(19) United States
(12) Patent Application Publication
(10) Pub. No.: US 2003/0164382 A1
(43) Pub. Date: Sep. 4, 2003

(54) Massage applicator for cosmetic compositions

(76) Inventors: Guy Thompson, Inverness, IL (US); Wendi Hutchinson, York (GB); Thomas F. Wiegner, Saint Charles, IL (US)

Correspondence Address: UNILEVER, PATENT DEPARTMENT, 45 RIVER ROAD, EDGEWATER, NJ, 07020, US

(21) Appl. No.: 10/085,602

(22) Filed: Feb. 27, 2002

(51) Int. Cl. B67D 5/08; B67D 5/14

(52) U.S. Cl. 222/55

(57) ABSTRACT

A specially adapted kit apparatus and method for delivering a cosmetic composition to human skin, preferably a flowable antiperspirant or deodorant composition, which provide enhanced antiperspirant and deodorant effects. The kit includes a cosmetic composition and a massage applicator apparatus. The method consists of massaging a cosmetic composition into human skin using the specially adapted kit.

### FIELD OF THE INVENTION

The present invention relates to an improved apparatus and method for dispensing cosmetic compositions, and more particularly, to an apparatus and method for dispensing an antiperspirant or deodorant composition using a massage applicator.

### BACKGROUND OF THE INVENTION

Many cosmetic compositions are known to be suitable for application to human skin. Antiperspirant or deodorant compositions can comprise a number of forms, such as a liquid or cream, gel or micronized powder, or spray and solid stick. Such compositions are dispensed in a variety of packages that are commercially available or otherwise known in the antiperspirant art. These products are designed to provide effective perspiration and odor control while also being cosmetically acceptable during and after application onto the underarm area or other areas of the skin.

Antiperspirant deodorant compositions are disclosed in U.S. Pat. No. 5,534,245 and International Patent Application WO 98/51185. International Patent Application WO 00/64302 discloses a package suitable for dispensing a flowable cosmetic composition.

Many of these antiperspirant and deodorant products, however, are cosmetically unacceptable to a large number of users because the products are perceived as being sticky and wet, taking a long time to dry after application to skin, and leave undesirable visible deposits on the skin.

Other methods of reducing sweat and odor have been tried. GB 1 240 275 discloses use of current flow via the body of a user to achieve bacteria kill and deodorizing effects. CN 1 256 116 discloses a physiotherapeutic instrument to deliver ozone wind massage. These are not practically appealing to a consumer.

Moreover, it is difficult to achieve more than a certain degree of sweat reduction. Without being bound by theory, the limit may be due to the number of sweat glands or pores that are open at any given time when an antiperspirant or deodorant is applied. The closed pores, deemed to be dormant, open at other times and become activated to functionally release perspiration or sweat. On the other hand, it is the open pores that are suitable for receiving delivery of antiperspirant or deodorant products.

An object of the present invention is to provide a specially adapted kit for delivering a cosmetic composition, preferably a flowable antiperspirant composition, which provides enhanced efficacy of the composition.

Another object of the present invention is to provide a method for delivering a cosmetic composition to human skin for enhanced efficacy of the composition.

Other objects of the present invention will become apparent to those skilled in the art by reference to the specification.

As used herein, the term “comprising” includes made up of, composed of, including, consisting and/or consisting essentially of. Except in the operating and comparative examples, or where otherwise explicitly indicated, all numbers in this description indicating amounts or ratios of material or conditions of reaction, physical properties of materials and/or use are to be understood as modified by the word “about”.

As used herein, the term “massage” includes manipulation of tissues (as by rubbing, kneading, vibrating, or tapping) with the hand or an instrument for therapeutic, experiential, sensorial, or cosmetic purposes.

### SUMMARY OF THE INVENTION

The present invention is based on the concept that, if application of antiperspirant and deodorant compositions is combined with massage, significantly improved functionality is achieved. Therefore, a specially adapted kit apparatus for delivering a cosmetic composition for topical application to human skin and a method of using it is provided, including:

a) a massage applicator apparatus comprising a power source, which may include manual generation of vibrationary action, driving an oscillating mechanism connected to an interface medium; the massage applicator apparatus further including means for delivering vibration to the interface medium; the interface medium optionally being provided with a cover seatable thereon; and

b) a cosmetic composition.

The power source may include an on and off control device and a switch. The applicator surface may have proturberances thrusting out from its outer surface. The massage applicator apparatus may further include a composition refill system and/or a composition delivery system.

### BRIEF DESCRIPTION OF THE DRAWINGS

The following figure is intended for purposes of illustration and example.

FIG. 1 is a perspective view of an embodiment of the present invention;

FIG. 2 is a cross-sectional view of the embodiment of FIG. 1 taken along line II-II.

### DETAILED DESCRIPTION OF THE INVENTION

The present invention relates to a specially adapted kit apparatus and method for delivering a cosmetic composition to human skin, preferably a flowable antiperspirant or deodorant composition, which provide enhanced antiperspirant and deodorant effects. Kit 10 includes a cosmetic composition 12 and a massage applicator apparatus 14. Cosmetic composition 12 may either be provided within and as a component of massage applicator apparatus 14 or separately applied from a base unit either directly to human skin or to massage applicator apparatus 14. Cosmetic composition 12 may be any cosmetic composition suitable for application to human skin, including antiperspirant compositions, deodorant compositions, compositions for the cleansing and care of human skin, skin lightening compositions, and combinations thereof. Preferably, cosmetic composition 12 is a cream or soft solid antiperspirant or deodorant composition. The cream and soft solid antiperspirant compositions exhibit a synergistic effect when applied to the human axilla by means of massage applicator apparatus 14.

Massage applicator 14 can be in any form, operated manually, mechanically, such as clockwork mechanisms, or driven by a power source, such as electrical or battery source, and other mechanisms for the generation of vibration, such as electromagnetic solenoids and magneto restrictive materials. Preferably, massage applicator 14 is a hand held apparatus including a power source 20 driving an oscillating mechanism 30 connected to a vibrating head or interface medium 40. Massage applicator 14 can further optionally include a composition refill system 50, a composition delivery system 60 for delivering composition 12 to interface medium 40, and means for delivering vibration 70 (also known as a flexible skirt), for actuating vibration of interface medium 40. Cover 80 is optionally provided, seatable over interface medium 40 to enclose and protect massage applicator apparatus 14.

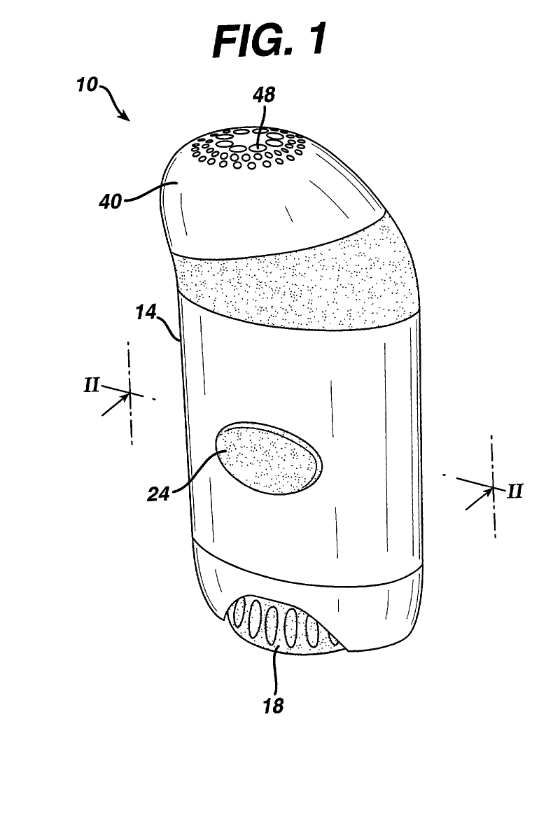

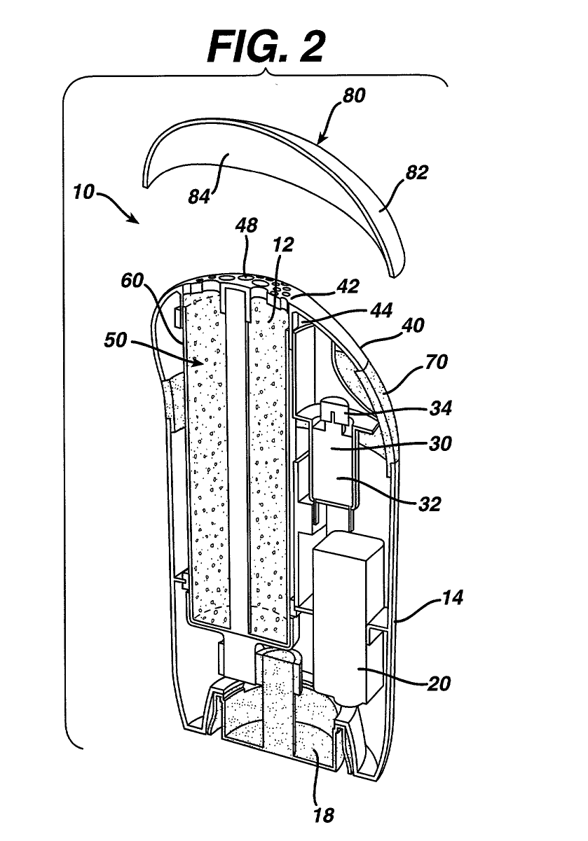

Referring to the accompanying drawings, FIG. 1 is a perspective view of a preferred embodiment of kit 10 of the present invention and FIG. 2 is a cross-sectional view of the embodiment of FIG. 1 taken along line II-II. In the preferred embodiment, kit 10 includes cosmetic composition 12 and massage applicator 14. Massage applicator 14 includes power source 20 driving an oscillating mechanism 30 connected to interface medium 40.

Power source 20 may include permanently or detachably installed disposable or re-chargeable batteries. Power source 20 may further include an on and off control device 22 (not shown), including a switch 24. Control device 22 may control power source 20 to operate for a set time or continuously. Optionally, control device 22 may simultaneously control power to oscillating mechanism 30 and to composition delivery system 60.

Oscillating mechanism 30 may be powered or manual, and may include an electrical mechanism, a motor, a solenoid, clockwork, and the like. Oscillating mechanism 30 provides vibration to interface medium 40 at set or variable frequencies and amplitude. Oscillating mechanism may further include offset weights 34.

Interface medium 40 may be formed integrally with oscillating mechanism 30 or may be formed as a separate member and attached to oscillating mechanism 30. Interface medium 40 includes an applicator outer surface 42 extending in a direction away from oscillating mechanism 30 and an inner surface 44 closest to oscillating mechanism 30. Outer surface 42 may be smooth or textured, and curved or flat. A textured outer surface 42 may have proturberances 46 thrusting out therefrom, which may be rounded masses or knobs (not shown). Interface medium 40 optionally has at least one exit orifice 48 therein.

In another aspect, composition 12 may be a solid stick antiperspirant or deodorant composition 13 (not shown), with solid stick composition 13 itself serving as interface medium and applicator surface. Thereby, the vibration or resonance may be transferred directly to the axilla via stick 13.

Further with reference to FIGS. 1 and 2, massage applicator 14 includes a composition refill system 50 in fluid communication with a composition delivery system 60 for delivering composition 12 to interface medium 40, and means for delivering vibration 70, for actuation of vibration of interface medium 40. Composition refill system 50 may include a refillable or disposable container, sachet, or combinations thereof. For example, when the contents of the container or sachet are exhausted, it may be replaced by another container or sachet. In the alternative, the container may be refilled from an external source of composition 12.

In the preferred embodiment, composition delivery system 60 may be provided with a pump system or a platform lift system. Composition delivery system 60 may include an actuating device for dispensing a dose of composition 12 to interface medium 40. Delivery system 60 may be automatically or manually driven.

Cover 80 may be provided, to be seated over interface medium 40 to enclose any exit orifices 48 when massage applicator apparatus 14 is not in use. Cover 80 includes outer surface 82 and inner surface 84 which takes an appropriate form to cooperate with applicator outer surface 42.

During operation of kit 10, with reference to FIG. 1, composition 12 is delivered to human skin according to the present invention by means of massage applicator apparatus 14 by turning on switch 24 to activate power source 20. Control device 22 may control power source 20 to operate for a set time or continuously. Power is delivered to oscillating mechanism 30 activating means for delivering vibration 70 (also known as a flexible skirt) to interface medium 40, thereby causing interface medium 40 to vibrate. In the meantime, composition delivery system 60 delivers composition 22 from product refill system 50 to exit orifices 48 in the vibrating interface medium 40. Massage applicator apparatus 14 is brought in contact with a location on human skin at applicator outer surface 42, thereby simultaneously exerting stress and strain or delivering a massage and composition 12 through exit orifices 48 to the point of contact on the skin. Thereby, composition 12 is spread and massaged into the human skin. Massage as used in the context of the present invention is meant to include manipulation of human tissues, as by rubbing, kneading, or tapping, be it manually or with the aid of an apparatus. Although kit 10 is useful for any type of cosmetic composition at any skin position, it is advantageously used for application of antiperspirant or deodorant compositions to human axillary regions.

Compositions

The present invention kit 10 is particularly suitable for flowable antiperspirant and deodorant compositions, preferably in cream form. Examples of suitable antiperspirant and deodorant compositions are as follows.

An antiperspirant composition according to the invention includes an antiperspirant active. The proportion of antiperspirant active present in the composition according to the invention may be about 1% to about 35% by weight of the composition, preferably at least about 5% by weight and more preferably about 15% to about 30% by weight of the base composition. A base composition herein excludes any propellant that may be employed.

Examples of suitable actives include aluminium salts, zirconium salts, aluminium and/or zirconium complexes, for example aluminium halides, aluminium hydroxy halides, zirconyl oxyhalides, zirconyl hydroxyhalides, and mixtures thereof. Specific examples include activated aluminium chlorohydrate, aluminium chlorohydrate, aluminium pentachlorohydrate and aluminium zirconium chlorohydrate. Useful zirconium salts include zirconium hydroxychloride and zirconium oxychloride. Other generally used actives will be known to those skilled in the art. Preferred actives include ZAG (Zirconium Aluminium Glycine), AAZG (Activated Aluminium Zirconium Glycine), and MCH (Activated Aluminium Chorohydrate). The antiperspirant active can be present in particulate form whereupon it is normally suspended in a suitable carrier fluid, which usually is water-immiscible, and which can be structured or thickened. Alternatively the active can be dissolved in a polar solution, such as for example in aqueous solution or in a polar low weight polyhydric alcohol such as propylene glycol, advantageously about 30% to about 60% by weight solution.

The deodorant compositions according to the present invention normally comprise about 0.01 to about 90% of a deodorant active. The deodorant active used in the cosmetics of the invention can be any deodorant active known in the art such as alcohols, in particular aliphatic monohydric alcohols such as ethanol or propanol, antimicrobial actives such as polyhexamethylene biguanides, e.g., those available under the trade name Cosmocil™ or chlorinated aromatics, e.g., triclosan available under the trade name Irgasan™, non-microbiocidal deodorant actives such as triethylcitrate, bactericides and bacteriostats. Yet other deodorant actives can include zinc salts such as zinc ricinoleate.

The carrier material for the compositions according to the invention can comprise one or more of volatile carrier fluids, one or more of non-volatile emollients, and it can be structured or thickened by one or a combination of thickener and/or structurant materials if required. The carrier material, including, where relevant, carrier materials providing additional properties such as emolliency, can often comprise up to about 99 wt %, in many instances about 5 to 90 wt % and particularly about 10 to about 70 wt % of the composition, or of the base composition, if mixed subsequently with a propellant. Where the composition comprises both hydrophilic and hydrophobic phases, the weight ratio of the two phases is often in the range of about 10:1 to about 1:10.

The antiperspirant or deodorant composition can consist of a mixture of particulate solids or a suspension of solids in a liquid medium, which can be thickened to reduce the rate of segregation or structured to produce a cream (soft solid) or even solid. Alternatively, the composition can be a mixture of liquid constituents, including a solution of an active in a carrier, such a composition often adopting the form of an oil-in-water or water-in-oil emulsion, which may be thickened or gelled.

The carrier material, which may be a fluid or a mixture of fluids, is often selected according to the physical form of the cosmetic composition, e.g. volatile low viscosity silicones, low molecular weight hydrocarbons, alcohols and water, and can be selected by those skilled in the art to provide appropriate physical and sensory properties for the product. It will be understood that certain fluid alcohols such as in particular ethanol can constitute both a carrier and a deodorant active simultaneously, though advantageously formulations containing such a material also contain an additional deodorant and/or antiperspirant active.

Volatile silicones are usually selected from cyclic polysiloxanes containing from 3 to 8 dialkylsilicone groups, especially dimethylsilicone groups and particularly 4 or 5 dimethylsilicone groups. Other useful volatile silicones can comprise linear polysiloxanes, preferably containing 4 or 5 alkylsiloxane groups, including terminal groups. Low molecular weight liquid hydrocarbons can comprise paraffin oils. Suitable alcohols can comprise monohydric alcohols, such as C3 to C10 aliphatic alcohols, dihydric alcohols such as glycol or propylene glycol or polyhydric alcohols such as glycerol or sorbitol. Carrier materials can provide additional desirable properties, such as polyhydric alcohols for example glycerol can act as a moisturising agent and volatile cyclomethicones can act as emollients.

The non-volatile emollient, if used in the composition, may consist of a single emollient compound or a mixture of emollients. Such emollients often have a solubility parameter of below 10 and many of from 5.5 to 9. They can typically include saturated fatty acids and fatty alcohol esters, ethers containing aliphatic and a polyalkylene group, hydrocarbons, water insoluble ethers, mineral oils and polyorganosiloxanes, and mixtures thereof.

Non-volatile silicones are often polyalkylsiloxanes, polyalkylarylsiloxanes or polyethersiloxanes having a viscosity of above about 10 mPa.s, such as up to about 5×10⁶ mPa.s at 25° C., including polymethylphenylsiloxanes or dimethylpolyoxyalkylene ether copolymers.

Emollient aliphatic esters, often containing about 12 to about 25 carbons, and preferably one substituent containing a chain of at least about 12 carbons. Examples include cetyl palmitate, butyl myristate, glyceryl stearate and propylene glycol monolaurate. The composition can comprise a liquid aliphatic ether which can provide emolliency, such as ethers derived from polyalkylene glycols and a low weight (e.g., up to about C6) alcohol, such as polypropylene glycol (10-15) butyl ether. The total amount of emollient materials within the composition is often within the range of about 1 to about 70 wt %.

The thickening or structurant agent, when required, is selected according to the product form of the cosmetic composition. The thickening or structuring agent can be organic (monomeric or polymeric) or inorganic and is usually chosen depending on the physical nature of the liquid phase to be thickened or structured, such as whether it is hydrophobic or hydrophilic. The amount is normally selected in order to attain the desired viscosity of the liquid or cream or desired resistance to penetration of a solid in accordance with the present invention.

Optionally, but preferably, soft solid or cream formulations herein usually have a hardness of at least about 0.003 N/mm² at 25° C. Hardness, especially of soft solids, can be measured by a conventional sphere indentation technique, using a Stable Micro systems TA.XT2I™ Texture Analyser. In some formulations in the form of soft solids herein, the so measured hardness is up to about 0.05 N/mm² at 25° C. and particularly up to about 0.02 N/mm² at 25° C. In other and harder formulations in stick form, their hardness is greater than about 0.05 N/mm² at 25° C. and particularly greater than about 0.1 N/mm² at 25° C.

The thickener or structurant can be any of a number of materials, including, for example, waxy structurants for a formulation containing a water-immiscible phase including hydrogenated vegetable oil, hydrogenated castor oil, fatty acids, such as 12-hydroxystearic acid (12-HSA), or ester or amide derivatives of such acids, beeswax, paraffin wax, microcrystalline waxes, silicone wax, and fatty alcohols, such as stearyl alcohol. The structurant can also be a fibre-forming gellant, of which 12-HSA is an example. Other examples include N-acyl amino acid amides and esters, including particularly GP-1 (N-Lauroyl-L-glutamic acid di-n-butylamide), lanosterol, combinations of a sterol and a sterol ester, such as especially β-sitosterol and χ-oryzanol, a polyesterified cellobiose, especially with a C8 to C10 aliphatic acid, threitol esters of and selected secondary amides of di or tri basic carboxylic acids, (e.g., 2-dodecyl-N,N′-dibutylsuccinimide) by themselves or in combination.

Polymeric materials for thickening include polymers such as polyamides, hydroxypropylcellulose, and natural or synthetic gums, such as polyglycerides including agar, agarose, pectin, or guars or mixtures or combinations thereof. One class of materials worthy of attention for thickening a water-immiscible phase includes derivatives of hydrolyzed starch or other polysaccharides, including in particular esterified dextrins, such as dextrin palmitate. A further class of polymers that is particularly directed to structuring an oil phase containing a silicone oil comprises polysiloxane elastomers. Suspending agents such as silicas or clays such as bentonite, montmorillonite or hectorite, including those available under the trademark Bentone can also be employed to thicken liquid compositions according to the invention. The composition can be thickened with non-polymeric organic gellants, including selected dibenzylidene alditols (e.g., dibenzylidene sorbitol).

The amount of structurant or thickening agent that can be employed in the invention compositions will depend upon the viscosity of a fluid formulation or extent of hardness of a solid formulation that the producer wishes to attain. The amount to be employed will, in practice, also vary depending on the chemical nature of the structurant or thickening agent. In many instances, the amount of structurant or thickening agent will be selected in the range of about 0.1 to about 25 wt %, and particularly about 1 to about 15 wt %.

Other ingredients contemplated within the personal deodorant or antiperspirants art can also be included in the compositions according to the invention, depending on the nature and form of the finished product. These include, for example, surfactants/wash-off agents, fillers, fragrances, antioxidants, preservatives and colouring agents. Such ingredients and their amounts of use are usually selected according to the physical and chemical form of the cosmetic composition.

Surfactants can comprise optionally up to about 15%, more commonly up to about 5% by weight of the total product, and are particularly useful in formulating emulsion antiperspirant or deodorant compositions, for example for use as pump formulations. Non-ionic surfactants are particularly preferred. It is often convenient to select a mixture of surfactants, such as one having a comparatively high hydrophilic-lipophilic balance (HLB) value, e.g., 8 to 18, and one having a comparatively low HLB value, e.g., 2 to 8, which can be introduced in suitable relative proportions to aftain an average HLB value of about 6 to 12.

Many suitable nonionic surfactants are selected from nonionic esters, ethers or amine oxides having an appropriate HLB value. Many preferred ionic surfactants comprise a polyoxyalkylene moiety, especially a polyoxyethylene moiety, e.g., 2 to 80, especially 5 to 60 oxyethylene units, or possibly with a polyoxypropylene content, to provide hydrophilicity. Other moieties providing hydrophilicity include polyhydric alcohols such as sorbitol or glycerol. The hydrophobic moiety is commonly derived from aliphatic alcohols or acids or amines containing about 8 to 50 carbons and particularly 10 to 30 carbons. Examples of suitable nonionic surfactants include ceteareth-10 to -25, ceteth-10 to -25, steareth-10 to -25, and PEG-15 to -25 stearate or PEG-8 distearate. Other suitable examples include C10-C20 fatty acid mono, di or tri-glycerides. Further examples include C18-C22 fatty alcohol ethers of polyethylene oxides.

Examples of surfactants which typically have a low HLB value of from 2 to 8 often comprise mono or possibly di fatty acid esters of polyhydric alcohols such as glycerol, sorbitol, erythritol or trimethylolpropane, including cetyl, stearyl arachidyl and behenyl derivatives.

Fillers can comprise up to about 20%, more commonly up to about 10% of the base composition and can act as supports for liquid ingredients. Suitable fillers include aluminium stearate, aluminium tri-stearate, calcium stearate, talc or finely divided polyethylene, an example of which is ACUMIST B18. The latter can also enhance skin feel properties.

Fragrances, when present, typically comprise up to about 4% of the total product and often from 0.1 to 1.5%.

Colouring agents, antioxidants such as ascorbic acid and tocopherol, and preservatives such as C1 to C3 alkyl parabens can be added as desired.

Other optional ingredients are other cosmetic adjuncts conventionally employed or contemplated for employment in antiperspirant or deodorant products.

### EXAMPLE 1

The following table lists examples of cream and soft solid antiperspirant and/or deodorant compositions suitable for use with the massage apparatus of the present invention. These examples are by way of illustration only and are not meant to be limiting in any way.

TABLE I

| | | | | | | | | | | | | | |
|---|---|---|---|---|---|---|---|---|---|---|---|---|---|
| Creams and soft solids | 10.1 | 10.2 | 10.3 | 10.4 | 10.5 | 10.6 | 10.7 | 10.8 | 10.9 | 10.1 | 10.11 | 10.12 | 10.13 |

Ingredients

| | | | | | | | | | | | | | |
|---|---|---|---|---|---|---|---|---|---|---|---|---|---|
| Silicone wax | | 2.5 | | | | 3 | | | | | | | |
| N-lauroyl-glutantic acid di-n- | | | | 1 | | | | | | | | | |
| butylamide | | | | | | | | | | | | | |
| Cetearyl Dimethicone/vinyl | | | | | | | | | | | | | 65.05 |
| dimethoicone crosspolymer and | | | | | | | | | | | | | |
| Cyclopentasiloxane | | | | | | | | | | | | | |
| Syncrowax ERLC (13) | | | 2.5 | | 5 | | | | | | | 3.75 | |
| Synchrowax HGL-C | | | | | 1.25 | | | | | | | | |
| Castor wax | | | 7.5 | | | | | 4 | | | | 1.25 | |
| Triacontenyl vinyl prrolidone | 5 | | | | | | | | | | | | |
| copolymer | | | | | | | | | | | | | |
| Stearyl alcohol | | | | | | | | 6 | | | | | |
| Paraffin wax | 5 | 7.5 | | | | | | | | | | | |
| Candelilla wax | | | | | | | | | 7 | | | | |
| C24/28 alkyl dimethicone wax | | | | | | | | | 3.5 | | | | |
| Silica | | | 1 | | | 1.5 | 1.5 | | | | | | 0.2 |
| Talc | | | | | 1.75 | | 6 | 5 | | | | | |
| Hydrohobic Clay Bentone 38 | | | | | | | 3 | | 0.5 | | | | |
| Anhydrous aluminium silicate | | | | | | | 6 | | | | | | |
| Microtbene powder | | | | | | | 6 | | | | | | |
| Propylene Carbonate | | | | | | | 1.5 | | | | | | |
| Cyclomethicone | | 64.5 | | | 61.5 | 63.5 | 38.3 | 59 | 46 | 50.8 | — | | |
| Tetraphenyl tetramethylsiloxane | | | | 53 | | | | | | | | | |
| C12-15 Alkyl benzoate | 64.5 | | 63.5 | | | 10 | | | | 12.7 | 63.5 | 64.5 | 4 |
| Dextrin palmitate | | | | 5 | | | | | | 10 | 10 | 5 | |
| Octyldodecanol | | | | 15 | | | | | | | | | |
| Isopropyl Myristate | | | | | | | | | | | | | |
| Neopentyl Glycol Diheptanoate | | | | | | | | | | | | | 5 |
| PPG14 Butyl ether | | | | | | | | 4.5 | | | | | |
| Dimethicone 10 cst | | | | | 5 | | 10 | | | | | | |
| Dimethicone 350 cst | | | | | | | | | 25 | | | | |
| PEG8 distearate | | | | | | | | | | | | | 2 |
| Stearyl dimethicone | | | | | | | | | | | | | 0.75 |
| POE 100 stearyl ether | | | | | | | 2 | | | | | | |
| POE 100 stearate | | | | | | | | 1 | | | | | |
| PPG1-PEG9-lauryl glycol ether | | | | | | | | | | | | | 2 |
| AACH | 25 | 25.5 | | | | 22 | | | | — | | 25.5 | |
| Milled AACH | | | 25.5 | 25.5 | | | | | | | 26 | | |
| ACH | | | | | | | | | 18 | — | | | |
| AZAG 7167 | | | | | 25 | | 25.7 | 20 | | 26.5 | | | 22.5 |
| Fragrance | 0.5 | | | 0.5 | 0.5 | | | 0.5 | | | 0.5 | | 0.5 |

Clinical Studies

Clinical studies have shown increased efficacy in sweat reduction, quicker drying and less stickiness using kit 10 including massage applicator apparatus 14 for delivering antiperspirant/deodorant composition 12 to the human axilla. Although not wishing to be bound by theory, one hypothesis is that the apparatus and method for applying antiperspirant or deodorant compositions opens up more or additional, dormant, skin pores, which may not be otherwise open at the time an antiperspirant and/or deodorant composition 12 would otherwise be applied. In theory, only about one third of the sweat glands in a given area are open at any one time, while two thirds are shut. The massage technique of the present invention makes more sweat glands available for accepting delivery of a cosmetic antiperspirant or deodorant composition, thereby achieving higher sweat reduction. In combination, massage applicator apparatus 14 and composition 12, constituting kit 10 of the present invention, are more efficaceus that either component alone, as will be further explained below with reference to the clinical trials.

Consumer clinical trials have been carried out with kit 10 of the present invention to apply a dose of soft solid type antiperspirant composition 12. These tests were a paired comparison with a regular applicator and demonstrated a significant increase in sweat reduction versus the regular application.

### EXAMPLE 2

An example of anti-perspirant composition 12 suitable for use in the present invention is shown in Table II.

TABLE II

| Raw Material | Weight % |
|---|---|
| Cyclopentasiloxane | 43.98 |
| C30-C45 Alkyl Dimethicone | 6.00 |
| Hydrogenated Castor Oil | 6.00 |
| Dimethicone | 10.00 |
| Talc | 8.00 |
| Aluminum Zirconium Trichlorohydrex GLY | 25.50 |
| Fragrance | 0.50 |
| Antioxidant | 0.02 |

### EXAMPLE 3

This example summarizes the results of a 5-day Antiperspirant Efficacy Study (Hotroom Test). The study was performed to investigate how varying the method of product application of delivering antiperspirant to the axilla will affect efficacy. Two product application techniques were compared: applying antiperspirant composition 12 using massage applicator apparatus 14 versus applying antiperspirant composition 12 via its standard pack. The soft solid antiperspirant composition 12 of EXAMPLE 2 was tested using an art-recognized gravimetric procedure.

The differences between the two product application techniques are shown in the Table III below.

TABLE III
% DIFFERENCE

| | | Appl 2 | Appl 3 | Appl 4 |
|---|---|---|---|---|
| Sample Comparisons | | 1 hour | 1 hour | 24 hour |
| A-test) Product | % Difference | 12% | 6.6% | 10% |
| Application using a | Lower 95% CL | 1.9% | −2.3% | 0.81% |
| Massager (low speed) | Upper 95% CL | 21% | 15% | 19% |
| B-control) Product | p-value | 0.02 | 0.13 | 0.04 |
| Application using | | | | |
| Standard Tap-38 soft | | | | |
| Solid pack | | | | |

These results indicate that product application technique using massage apparatus 14 was significantly better (p<0.05) at post treatment sweat collections 1-hour after the second product application and 24-hours after the fourth product application. The results show a synergy between massage apparatus 14 and composition 12.

### EXAMPLE 4

This study is a follow-up of the massage applicator apparatus 14 study of Example 1. The objective of this test was to determine how quickly the massage apparatus 14 application enhances efficacy by adding sweat collection 1-hour after the first product application.

This example summarizes the results of a 4-day Antiperspirant Efficacy Study (Hotroom Test). Two product application techniques were compared: applying antiperspirant composition 12 using massage apparatus 14 versus applying antiperspirant composition 12 via its standard pack. The soft solid antiperspirant composition of Example 2 was tested for sweat reduction using an art-recognized gravimetric procedure.

The differences between the two product application techniques are shown in the Table IV below.

TABLE III
% DIFFERENCE

| | | Appl 2 | Appl 3 | Appl 4 |
|---|---|---|---|---|
| Sample Comparisons | | 1 hour | 1 hour | 24 hour |
| A-test) Product | % Difference | 6.6% | 4.7% | 7.5% |
| Application using a | Lower 95% CL | −0.27% | −3.0% | 2.0% |
| Massager (low speed) | Upper 95% CL | 13% | 12% | 13% |
| B-control) Product | p-value | 0.058 | 0.21 | 0.01 |
| Application using | | | | |
| Standard Tap-38 soft | | | | |
| Solid pack | | | | |

These results indicate that product application technique using massage apparatus 14 was significantly better (p≦0.10) at post treatment sweat collection 1-hour after the first product application. Although the p-value was a little bit greater than 0.05 (p=0.058), this result provides some indication that efficacy is quickly enhanced after one product application.

It should also be noted that kit 10 apparatus and method of the present invention imparted good sensory properties to the user, providing a novel sensorial experience to the antiperspirant/deodorant application process, which was particularly pleasant for the user. For example, the kit 10 apparatus and method of the present invention provided superior feel upon application and minimized the whitening effects of antiperspirant/deodorant compositions 12.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A kit for delivering a cosmetic composition for topical application to human skin comprising:
a) a massage applicator apparatus comprising a power source driving an oscillating mechanism connected to an interface medium;
said massage applicator apparatus further comprising means for delivering vibration to said interface medium;
said interface medium having at least one exit orifice therein; and
b) a cosmetic composition.

2. The package of claim 1 wherein said power source comprises an on and off control device.

3. The kit of claim 1 wherein said power source comprises a switch.

4. The kit of claim 1 wherein said interface medium comprises an applicator outer surface and an inner surface;
and wherein said applicator surface comprises proturberances thrusting out therefrom.

5. The kit of claim 1 further comprising a composition refill system.

6. The kit of claim 1 further comprising a composition delivery system.

7. The kit of claim 1 further comprising a cover seatable over said interface medium.

8. A method of delivering a cosmetic composition for topical application to human skin comprising the use of a kit comprising:
a) a massage applicator apparatus comprising a power source driving an oscillating mechanism connected to an interface medium;
said massage applicator apparatus further comprising means for delivering vibration to said interface medium; and
b) a cosmetic composition.

9. The method of claim 8 further comprising controlling said power source using an on and off control device provided therefor.

10. The method of claim 8 wherein said power source comprises a switch for turning said power source on and off.

11. The method of claim 8 wherein said interface medium comprises an applicator outer surface and an inner surface;
wherein said applicator surface comprises proturberances thrusting out therefrom.

12. The method of claim 8 wherein said kit further comprises a composition refill system.

13. The method of claim 8 wherein said kit further comprises a composition delivery system.

14. The method of claim 8 wherein said kit further comprises a cover seatable over said interface medium.

15. A method of delivering a cosmetic composition for topical application to human skin comprising the use of a kit comprising:
a) a massage applicator means for delivering massage to said skin; and
b) a cosmetic composition.

16. The method of claim 15, wherein said massage applicator means comprising an interface medium, wherein the geometry of said interface medium is selected from the group consisting of an interface medium that is substantially smooth, an interface medium comprising proturberances thrusting out therefrom, and combinations thereof.
